(19) United States
(12) Patent Application Publication
(10) Pub. No.: US 2001/0052451 A1
(43) Pub. Date: Dec. 20, 2001

(54) Plastic conveyor belt modules with electromagnetically-welded attchments

(76) Inventors: Hans Ruoss, Metairie, LA (US); Terral A. Ridgell, Hammond, LA (US); Christopher G. Greve, Covington, LA (US)

Correspondence Address: JAMES T. CRONVICH, THE LAITRAM CORPORATION, 220 LAITRAM LANE, HARAHAN, LA, 70123, US

(21) Appl. No.: 09/876,548

(22) Filed: Jun. 7, 2001

Related U.S. Application Data
(60) Provisional application No. 60/211,522, filed on Jun. 14, 2000.

(51) Int. Cl. B65G 17/08

(52) U.S. Cl. 198/853

(57) ABSTRACT

A plastic conveyor belt module including a base member and an attachment member bonded together by an electromagnetically welded bond material that forms a fused joint between the base member and the attachment member. The joint is formed between a base weld region and an attachment weld region with the electromagnetically welded bond material forming a firm bond at the interface between the two regions. A welding workstation includes a high-frequency generator with its output coupled to a work coil. A fixture nests the base and attachment members together with the bond material at the joint close to the work coil. Ferromagnetic or other electrically conductive particles capable of carrying eddy currents embedded in the bond material are heated inductively by the high-frequency signal emitted by the work coil. The heat is also transferred to the adjacent weld regions of the base and attachment members to fuse them together.

### CROSS REFERENCE TO RELATED APPLICATIONS

This application claims the benefit of U.S. Provisional Application Ser. No. 60/211,522, filed on Jun. 14, 2000, and entitled “Plastic Conveyor Belt Modules With Electromagnetically Welded Attachments.”

### BACKGROUND

This invention relates to plastic conveyor belt modules and, more specifically, to modules including electromagnetically welded attachments.

Modular plastic conveyor belts or chains are widely used in many industrial applications to transport articles through a plant. Because, unlike metal belts, plastic belts do not corrode, they are especially preferred in food- and beverage-handling applications. Modular plastic belts or chains are constructed of a series of rows of modules interconnected typically at hinge joints between consecutive rows by hinge pins into an endless conveyor belt. Each row may include one or more modules depending on the desired width of the belt or chain. Each module is generally formed of a thermoplastic polymeric material in an injection-molding process. Usually each mold consists of two mold halves that come together to form the mold cavity into which molten plastic is injected. The injected plastic is then solidified under pressure. After sufficient time, the mold halves are separated and the solid molded module is ejected.

A large percentage of the cost of a molded module is the cost of machining the mold. For this reason, simple, two-piece molds are preferable to complex, multi-piece molds. More complicated modules that include unitarily molded appurtenances such as curved flights, perforated flights, or hold down tabs, for example, require complex and expensive molds. Friction-top modules are made of a strong and slick base to carry belt tension with low-friction characteristics for easy running topped by a high-friction rubber-like material to engage conveyed articles. Friction-top modules are typically made in a two-step injection-molding process in which the low-friction base is molded first in a two-piece mold and then the high-friction top is molded onto the base in a second pair of mold halves or with a different top mold half. These overmolding or two-material molding processes require more than two mold pieces. Furthermore, the quality of the bond between the two materials depends on critical temperature and time settings. Bonds between belt module base components and overlying conveying surface materials can also be formed outside of the mold in other ways, such as by gluing. But gluing can be a messy process.

Some attachments are physically bonded to belt modules with fasteners made of various materials, such as steel. But using fasteners can be expensive and time-consuming, as well as limited in flexibility.

Thermoplastic parts of the same material or different materials can be joined by a number of other techniques that create fusion temperature at the joint interface. These techniques include: a) sonics, vibration, or spin welding to develop friction by rapidly rubbing the tightly held parts together; and b) hot platens or hot gases to soften the parts to be joined at the joint interface. These techniques are effective in many applications, but are less desirable for bonding attachments to belt module bases because of increased tooling expense, a limited range of joint designs, and longer manufacturing cycle times.

Thus, there is a need for a belt module that is manufactured with permanently bonded attachments without resorting to expensive and complex machine mold cavities and multi-step mold processes better suited for lower-volume products.

### SUMMARY

This need and other needs are satisfied by plastic conveyor belt modules having features of the invention. Such a plastic conveyor belt module includes a base member and an attachment member, such as a flight or a rubber-like article-engaging material, bonded together by an electromagnetically welded bond material that forms a fused joint between the base member and the attachment member. Linking structure on each base member allows base members to be linked together to form a conveyor belt or chain. The joint is formed between a base weld region and an attachment weld region with the electromagnetically welded bond material forming a bond at the interface between the two regions. The base member and the attachment are preferably separately molded and joined electromagnetically by a bond material that includes electrically conductive particles. Electric currents induced in the conductive particles heat the bond material and fuse the base member to the attachment member in a strong, permanent joint. A belt module having attachments manufactured in this way allows for a variety of standard- or custom-molded attachment members to be bonded to a common base member. Thus, simple molds can be made for each attachment member and for the base member, instead of a complex mold for each version of belt module with attachment.

### BRIEF DESCRIPTION OF THE DRAWINGS

These and other features, aspects, and advantages of the invention are better understood by reference to the following description, appended claims, and accompanying drawings, in which:

FIG. 1 is an isometric view of a portion of a conveying system transporting articles up an incline on a conveyor belt constructed of modules having features of the invention;

FIGS. 2A-2D are, respectively, pictorial exploded, side elevation exploded, pictorial, and side elevation views of a conveyor belt module as in the conveyor belt of FIG. 1;

FIGS. 3A-3C are, respectively, exploded isometric, exploded side elevation, and side elevation views of another version of belt module embodying features of the invention;

FIG. 4 is an isometric view of an electromagnetic welding station used in the manufacture of modules such as those in FIGS. 2 and 3;

FIG. 5 is an enlarged view of the working area of the welding machine of FIG. 4 welding a module as in FIG. 2.

### DESCRIPTION OF PREFERRED EMBODIMENTS

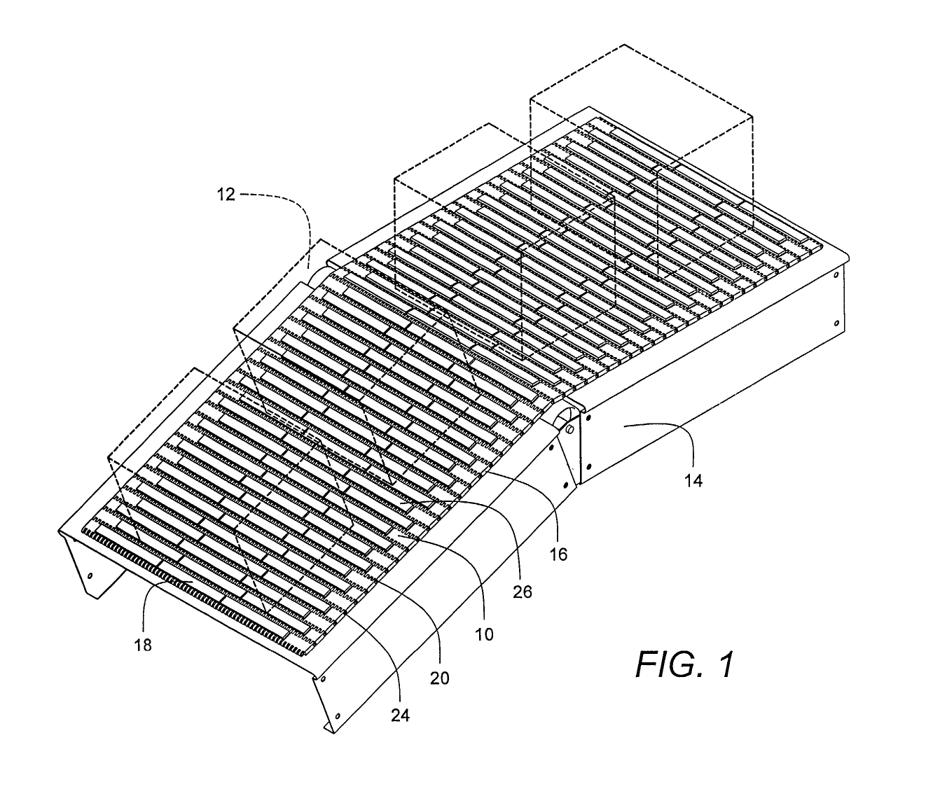

FIG. 1 illustrates a modular plastic conveyor belt constructed of modules embodying features of the invention. The conveyor belt 10 is used to carry articles 12 up an incline. The belt 10 is supported in a conveyor frame 14. The belt is a modular plastic conveyor belt constructed of a series of rows 16 of belt modules 18. Each row includes a plurality of modules arranged side by side. Linking structure in the form of hinge elements 20 extending in the direction of belt travel from leading and trailing ends of each module include transversely aligned hinge eyes 22. The hinge elements of each row of modules are interleaved with the hinge elements of a consecutive row and hingedly interconnected by a hinge pin 24 disposed in the transverse passageway formed by the aligned hinge eyes to form a conveyor belt. An example of such a belt is the INTRALOX® Series 900 conveyor belt manufactured and sold by Intralox, Inc. of Harahan, La. In the particular embodiment of FIG. 1, rubber-like attachment members 26 bonded to the upper surface of the modules provide a high-friction conveying surface suitable for carrying articles up or down inclines.

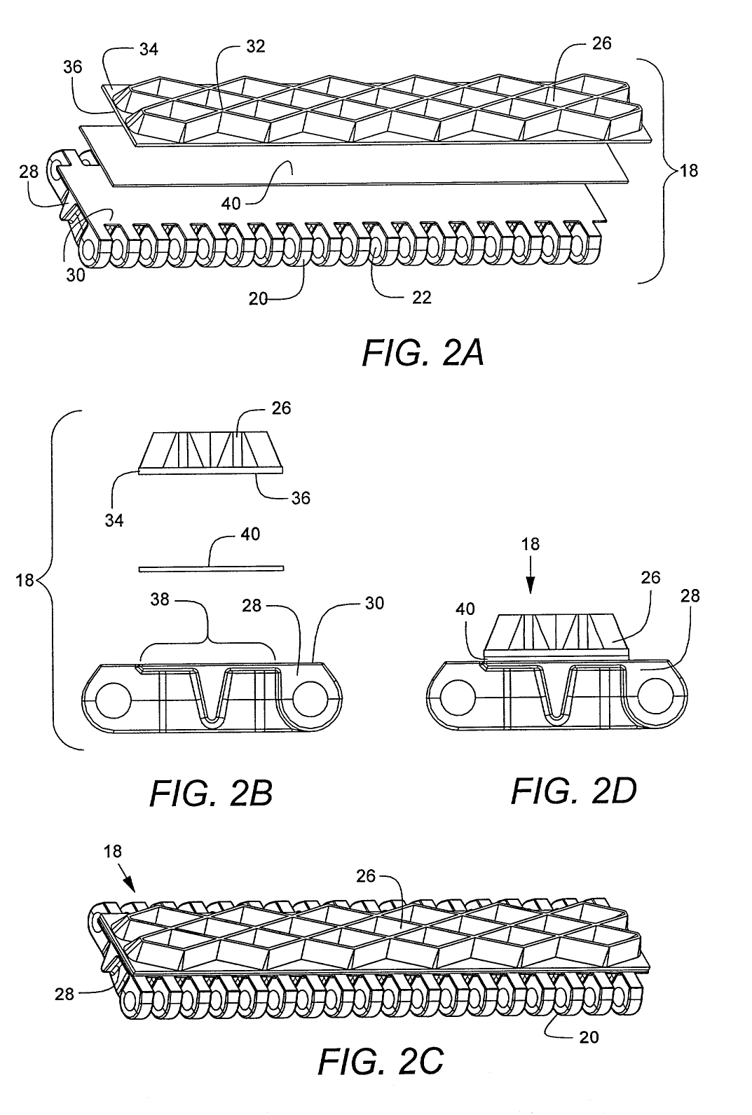

Interior modules 18 of the belt of FIG. 1 are shown in more detail in FIGS. 2A-D. Each module 18 includes a base member 28, which includes spaced apart hinge elements 20 on each end. Hinge eyes 22 are formed in the hinge elements to admit a hinge pin. The base member is preferably made of a strong material to handle the tension, or pull, of the belt, as well as to support the weight of conveyed articles. The base member is also preferably a low-friction material that slides easily along supporting wearstrips and other bearing surfaces on the conveying path. Typical materials are polymeric materials, including thermoplastic materials such as polyethylenes, polypropylenes, acetals, nylons, and polyamides. These materials are particularly useful in injection molding base members. Although injection molding is the preferred method of forming the base members, they could alternatively be formed otherwise, such as by machining.

The interior module 18 also includes a generally flat upper surface or deck 30. The attachment member 26 shown in this example is molded of a rubber or rubber-like polymeric material formed with a diamond-shaped article-engaging surface 32. The article-engaging surface extends upwards from a thin mat 34. The underside surface 36 of the mat serves as an attachment weld region that can be bonded to a base weld region 38 of substantially similar shape and area on the upper deck of the base member. A bond material 40, shown in FIG. 2 as a thin sheet, is sandwiched between the base weld region and the attachment weld region. In an electromagnetic bonding process to be described subsequently, the bond material is used to thermally fuse the attachment member to the base member to form the belt module shown in FIGS. 2C-D.

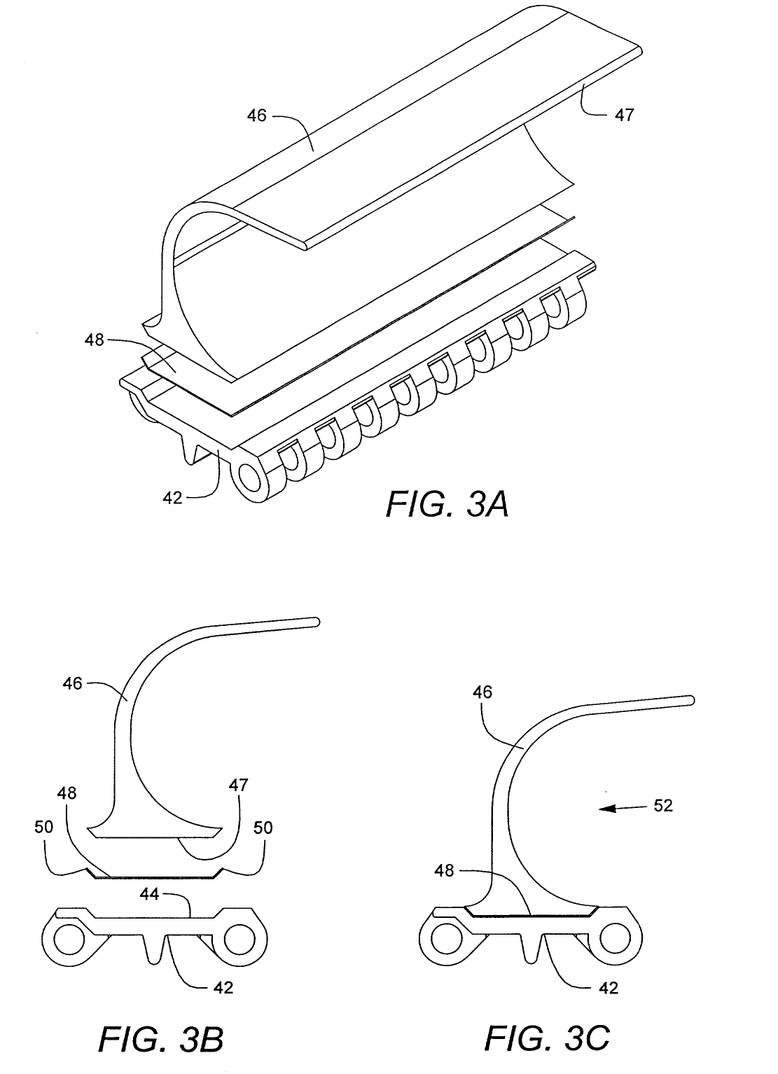

Another example of a belt module comprising an attachment member welded onto a base member is shown in FIGS. 3A-C. The base member 42, like the base member 28 in FIG. 2, is preferably injection-molded of a polymeric material. The top surface of the base member includes a recessed base weld region 44 on an upper deck. A flight attachment member 46 includes a lower flight attachment weld region 47 having substantially the same dimensions as the base weld region. The attachment member is bonded to the base member by a weld bond material 48 in the form of a sheet. Edges 50 of the sheet are bent to conform to the recessed base weld region 44. When the base and attachment members are bonded together at a weld joint, they form the flighted module 52 shown in FIG. 3C.

One skilled in the art can appreciate that many styles of attachments, such as flights, high-friction surfaces, cleats, roller assemblies, sideguards, and holddown tabs, to name a few, could be joined to standard base members to form a variety of useful belt modules for a wide range of applications. In this way, a small number of simple standard base molds could be maintained along with special attachment molds rather than individual expensive and complex custom molds for each base/attachment module.

The example modules shown in FIGS. 2-3 are formed by individually molding the base member and the attachment member in separate molds. The base member and the attachment member are then electromagnetically welded together to form a fused joint between the two members. The process of electromagnetically welding polymeric materials together using an electromagnetically active material as a bond at the interface between the two workpieces to be joined is now described. An example of an apt process for use with modular plastic conveyor belts is the EMAWELD® process of Emabond Systems, a division of Ashland Specialty Chemical Company, Norwood, N.J.

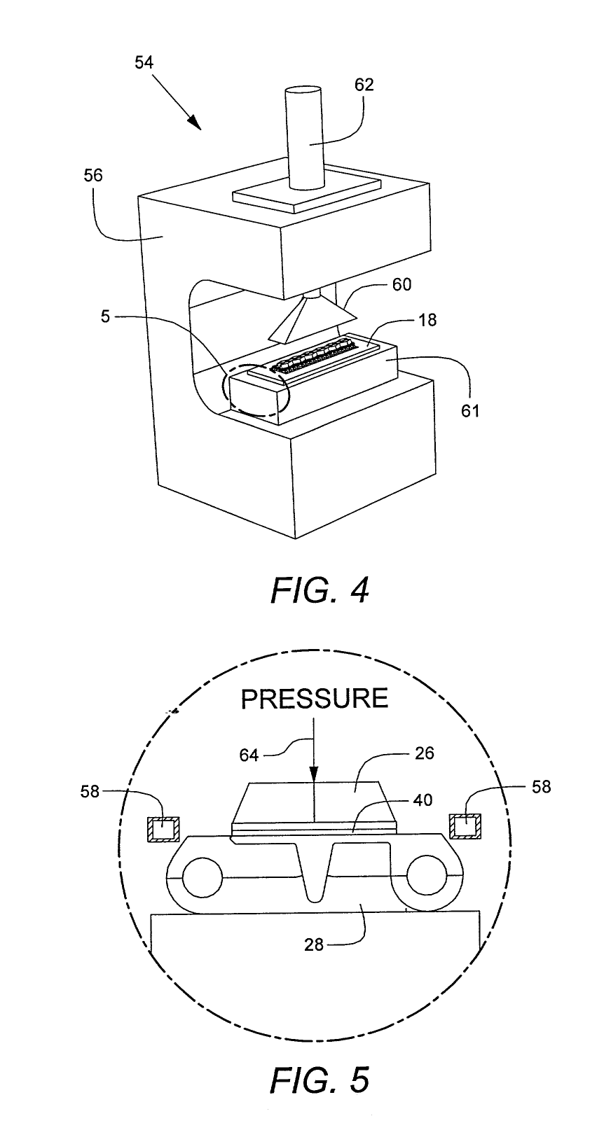

As shown in FIGS. 4-5, a workstation 54 contains the equipment necessary to perform the welding process. The equipment can be purchased from Emabond Systems or designed with their assistance or independently. The workstation contains an induction generator 56 that converts line power to a 3-8 MHz output signal at 2-5 kW. The oscillating output signal is applied to work coils 58, or inductors, which may be water-cooled through a hollow core. Fixtures form placement nests 60, 61 to hold the base 28 and attachment 26 members in position close to the work coils. A press 62 closes the nests together and applies pressure to the module members in the direction of arrow 64. The bond material, such as EMAWELD® electromagnetic material from Emabond Systems, is available in various forms. In the examples shown, the electromagnetic weld material 40 is in the form of a sheet at the interface of the base member 28 and the attachment member 26. The weld material is generally based upon the polymeric materials to be joined and is compounded with fine particles of iron, stainless steel, or other magnetic materials.

The induction generator 56 generates a signal of 3-8 MHz that is applied to the work coils. This high-frequency signal, by electromagnetic induction, causes the particles, such as ferromagnetic particles or other electrically conductive particles capable of carrying eddy currents, embedded in the weld material to rapidly heat up the weld material to its fusion temperature. The base and attachment weld regions are also heated sufficiently to cause them to fuse at the interface in a firmly bonded joint under pressure applied by the press.

The work coils 58 are preferably made from round, square, or rectangular tubing and are water-cooled. The coils are preferably closely positioned next to the nests for efficient transfer of inductive power to the weld material.

The process is as follows. First, the electromagnetic weld material is disposed in the joint between the weld regions of the base and the attachment members. The base and attachment members are placed together in the nests. The press then presses the workpieces together, and the generator energizes the work coils. The weld material heats and starts to melt the weld regions of the base and the attachment. After welding, the electromagnetic bond material has fused to the base and the attachment members in polymer to polymer linkages. These linkages ensure a neat and strong joint between the base member and the attachment member. Thus, conveyor belt modules having a variety of characteristics can be made without resorting to complex and expensive molds.

As a further benefit, the welding process is reversible to a certain extent. Resubjecting the welded module to an electromagnetic field of sufficient strength heats the weld material to soften the joint and weaken the bond so that the attachment member can be separated from the base member. This can be useful in rapidly prototyping and testing various designs and in replacing less expensive components from more complex, reusable components.

Although the invention has been described in detail with reference to preferred versions, other versions are possible. For example, attachments other than a high-friction rubber mat and a curved flight can be welded onto a common base. Modules including perforated flighted attachments or other topological features difficult to mold in a single two-half mold are especially adaptable to the electromagnetic welding process. Therefore, the spirit and scope of the claims are not limited to the preferred versions described in the specification.

What is claimed is:

1. A plastic conveyor belt module, comprising:
a base member including linking structure for linking the base member to other base members;
an attachment member; and
an electromagnetically welded bond material forming a fused joint between the base member and the attachment member.

2. A plastic conveyor belt module, comprising:
a base member including linking structure for linking the base member to other base members and further including a base weld region;
an attachment member including an attachment weld region;
an electromagnetically welded bond material at the interface between the base weld region and the attachment weld region forming a bond between the attachment member and the base member at the interface.

3. A plastic conveyor belt module, comprising:
a base member including linking structure for linking the base member to other base members into a conveyor belt and further including an upper surface;
an attachment member for engaging articles carried on the conveyor belt module, the attachment member including an attachment surface;
a bond material including electrically conductive particles disposed between the upper surface of the base member and the attachment surface of the attachment, the bond material being fused to the upper surface of the base member and to the attachment surface of the attachment member by heating the electrically conductive particles in the bond material through electromagnetic induction.

4. A flighted conveyor belt module, comprising:
a base member including linking structure for linking the base member to other base members and further including a base weld region;
a flight member having a flight weld region; and
an electromagnetically welded bond material at the interface between the base weld region and the flight weld region bonding the flight member to the base member.

5. A high-friction conveyor belt module suitable for conveying articles in inclined conveying paths, comprising:
a base member including linking structure for linking the base member to other base members and further including an upper surface with a base weld region;
an article-engaging material having a high coefficient of friction relative to the base member and including a weld region; and
an electromagnetically welded bond material at the interface between the base weld region and the weld region of the article-engaging material bonding the article-engaging material to the upper surface of the base member to engage conveyed articles in high-friction contact.

6. A plastic conveyor belt module, comprising:
a base member formed in an injection-molding process and including linking structure for linking the base member to other base members;
an attachment member formed separately of the base member in an injection-molding process; and
an electromagnetically welded bond material forming a fused joint between the base member and the attachment member.
